(19) United States
(12) Patent Application Publication
(10) Pub. No.: US 2022/0092136 A1
(43) Pub. Date: Mar. 24, 2022

(54) SEARCH ENGINE OPTIMIZATION TEST TOOL

(71) Applicant: Sony Interactive Entertainment LLC, San Mateo, CA (US)

(72) Inventor: Ravi Kumar Pampana, Foster City, CA (US)

(21) Appl. No.: 16/816,799

(22) Filed: Mar. 12, 2020

(51) Int. Cl. G06F 16/958; G06F 40/106; G06F 40/166; G06F 40/143

(52) U.S. Cl. CPC G06F 16/958; G06F 40/143; G06F 40/166; G06F 40/106

(57) ABSTRACT

A search engine optimization (SEO) test tool for a web page authoring system operable to create a web page for publication. The SEO test tool is invoked prior to publication of the web page, and performs a plurality of tests to determine if at least predetermined ones of the data elements included in the web page being created conform to the pre-defined rules of the search engine. The test tool identifies data elements that conform to the pre-defined rules and data elements that do not conform to the pre-defined rules; and causes a display of at least some of the non-conforming data elements.

### (1) FIELD OF THE INVENTION

This invention relates to search engine optimization and, more particularly, to a search engine optimization tool that can be easily used by the author of a web page before that web page is published for searching by a search engine.

### (2) BACKGROUND OF THE INVENTION

Search engines are well-known software systems that perform searches on networks, such as the World Wide Web for particular information that is requested in a search inquiry. Well known search engines include those offered by Google, Bing, Yahoo, Amazon, Adobe and more. Typically, a search inquiry is entered in human language (e.g. English or French or German, etc.) in a browser by a user searching for particular information. The results of the search are presented, or displayed, as a number of web pages, referred to as search engine results pages (SERPs) that satisfy the search inquiry. The search that is responsive to a user's inquiry contains information, such as text, links, hyperlinks, meta tags, and the like, that have been collected by a web crawler.

Typically, when creating a web page, or pages, the objective of the author is to create a web page that is recognized by several search engines, especially since the author does not know, ahead of time, which search engine the user who enters the search inquiry is likely to use. Web pages that are found by a search engine are indexed and presented in response to the user's inquiry in a ranking, which is intended to rank the SERPs in the order which has more content that satisfies the inquiry. That is, the ranking of SERPs is based, at least in part, on the number of links, hyperlinks, meta tags and text included in the SERP that more closely match the information entered by the user in his search request.

Search engines have pre-defined rules to which web pages are expected to conform. Web pages that have greater conformance to these rules generally attain higher rankings and, thus, are more likely to be accessed in response to a search. There are several authoring applications that are available to authors of web pages that assist in the creation of the web page. Examples of such applications include those from WordPress, Wix and Shopify. The search engine enterprises noted above provide software for an author to create a web page to be searched by Adobe, Google, Bing, Yahoo, Amazon, etc. While the WordPress, Wix, Squarespace, . . . applications are designed to assist in the creation of web pages that conform to the pre-defined rules of most search engines, editing of the resultant web pages by the author might produce a web page having one or more data elements that are non-conforming. Such non-conforming data elements may adversely affect the ranking of that web page. However, this problem of non-conformance may not be realized until that web page is published, or “goes live,” and is found by the search engine. That is, although the web page authoring applications noted above include search engine optimization tools (SEO tools), those tools do not identify non-confirming web pages until the web pages are published, which often requires time-consuming and laborious effort to isolate and correct the non-conforming data elements. Likewise, authors that use the authoring software of, for example, Adobe Experience Manager, Google Sites, Yahoo, Bing Webmaster, etc. to create web pages directly might author web pages that contain non-conforming data elements. While some of this authoring software includes SEO tools that prepare reports on certain identified non-conforming data elements, these tools are limited for use with web pages that are published.

Accordingly, authors are not notified of errors in the web pages they create until those web pages are published. There is a need for an SEO tool that identifies non-conforming web pages, that is, web pages that contain one or more data elements that do not conform to the pre-defined rules of search engines, before the web pages are published. Advantageously, such an SEO tool would notify the author promptly, while the web page creation is in progress and before publication, so that remedial and/or corrective action can be taken. This improves the efficiency and quality of the web page and promotes higher ranking of the SERP.

### SUMMARY OF THE INVENTION

Therefore, the present invention is directed to a search engine optimization (SEO) test tool for a web page authoring system, implemented in software, that tests the data elements of the web page for conformance with pre-defined rules of the search engine, before the web page is published.

The SEO test tool is implemented preferably as a software module that identifies those data elements of the web page that conform with the pre-defined rules of the search engine and those data elements that do not. The test tool includes an output that causes the display of at least some of the non-conforming data elements.

In an embodiment, the SEO test tool can be invoked by a user, such as a web page author, before and/or after the web page is published. When invoked before the web page is published, the SEO test tool performs a first plurality of tests on the data elements of the web page; and when invoked after the web page is published, the SEO test tool performs a second plurality of tests on the data elements of the web page. Many of the first and second plurality of tests can be identical; and many of the tests performed after the web page is published need not be the same as some of the tests performed before the web page is published.

### BRIEF DESCRIPTION OF THE DRAWINGS

The following detailed description, given by way of example, will best be understood when read in conjunction with the accompanying drawings in which:

FIG. 1 is a flow chart illustrating how the SEO test tool is invoked before the web page created by the user is published;

FIG. 2 is a flow chart illustrating the use of the SEO test tool when creating web pages;

FIGS. 3A and 3B are flow charts illustrating how the SEO test tool operates;

FIGS. 4A and 4B are flow charts of another embodiment of the SEO test tool;

FIGS. 5A-5F illustrate the display of test tool results obtained before a web page is published; and

FIGS. 6A-6E illustrate the display of test tool results obtained when a published web page is tested for conformance with search engine rules.

### DETAILED DESCRIPTION

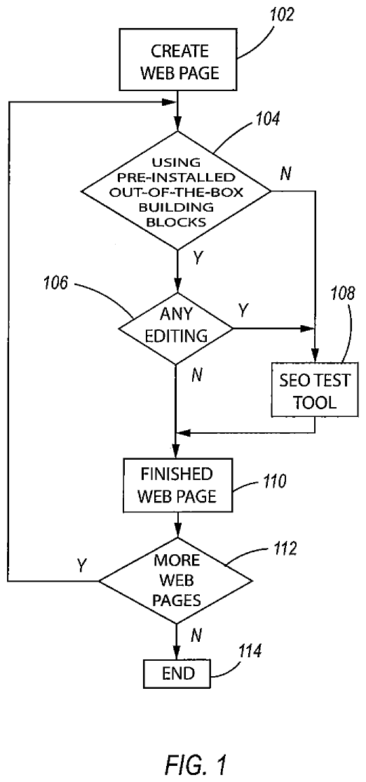

Referring now to the drawings, FIG. 1 illustrates a flow chart that describes how the SEO test tool is invoked. In the embodiment depicted in FIG. 1, the SEO test tool is invoked when the web page author, hereinafter the user, operates the authoring software, such as Adobe Experience Manager. The SEO test tool may be invoked at any stage of the authoring process; and FIG. 1 illustrates the tool is invoked at step 102 when the user creates the web page.

Query 104 of the SEO test tool asks whether the authoring software operated by the user is pre-installed out-of-the-box authoring software comprised of building blocks, such as the authoring software from Wix.com, or the authoring software of Wordpress (or other commercially available out-of-the-box authoring software). Such authoring software includes built-in tools to guide the user in the creation of a web page having data elements that conform to the pre-defined rules of most search engines. Consequently, it is expected the web page created by that software will conform to the standards of most (if not all) search engines. Accordingly, query 104 may be answered in the affirmative.

Query 106 then asks if the user is editing the web page created by that pre-installed out-of-the-box authoring software. That is, the query is made as to whether the user is modifying, or has modified, the web page he/she has created. If query 106 is answered in the negative, that is, if the user has made no edits and accepts the web page created by the out-of-the-box authoring software, the process advances to step 110 and the creation of the web page is finished. Then, query 112 asks if the user is creating more web pages. If this query is answered in the affirmative, the process returns to query 104 and the foregoing process illustrated in FIG. 1 is repeated. If the user has completed his creation of all web pages, query 112 is answered in the negative and the process ends at 114.

Returning to query 104, if the user is not using pre-installed out-of-the-box authoring software, this query is answered in the negative. For example, the user may be using Adobe Experience Manager which permits the user to build a web page that is not created solely with an authoring template, such as the templates found in the Wordpress or Wix or Squarespace authoring software. Should that be the case, the process advances to step 108 in which the SEO test tool of the present invention is invoked. That is, the SEO test tool, which preferably is embodied in a module, is invoked while using, or after use of, the authoring software. The SEO test tool is described below.

As also illustrated in FIG. 1, if the user operates pre-installed out-of-the-box authoring software (query 104 is answered in the affirmative) but edits the web page created by that software, query 106 is answered in the affirmative. Consequently, the process advances to step 108 and the SEO test tool is invoked. As will be described the SEO test tool determines if the web page created by the author conforms to the pre-defined rules, or standard, of most search engines. The tool causes a display of non-conforming data elements that comprise the web page, thereby giving the user the opportunity to make edits, corrections and revisions in the web page being created so as to conform to the search engine standards. Such edits, corrections and revisions are made before the web page is published, that is, before the web page goes “live,” which makes the authoring process far more efficient than if corrections and changes would otherwise be made after web page publication.

After using the SEO test tool of the present invention, the process advances to step 110, query 112 and ultimately, the authoring of the web page is finished at 114.

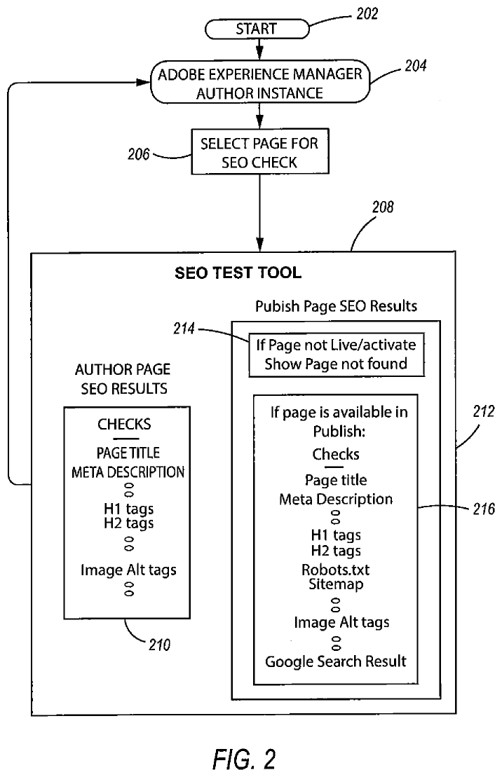

FIG. 2 is a flow chart that shows, in greater detail, the operation of the SEO test tool of the present invention. The SEO test tool is invoked at step 202 and advances to be used with the user's authoring system at step 204. In the embodiment of FIG. 2, it is assumed the user is using the Adobe Experience Manager. The process advances to step 206 at which a web page is selected to be checked by the SEO test tool. In one embodiment, the web page that is selected is the web page being created, or having just been created, by the user. In another embodiment, the user has created a number of web pages; and the user selects, at step 206, a web page to be checked.

The process then advances to step 208, at which the SEO test tool is operated. As shown in FIG. 2, the test tool may operate, at step 210, on the web page prior to the publication of that web page. The test tool also may operate, at step 212, on the web page that has been published. The SEO test tool comprises a plurality of tests to determine if at least predetermined data elements in the web page created by the authoring system conform to the pre-defined rules of the typical search engine. It will be appreciated, the most widely used search engine today is the Google search engine; and in the preferred embodiment, the SEO test tool performs tests to determine if the web page, and particularly, the data elements in the web page conform to the pre-defined rules of the Google search engine. If the web page conforms to the Google rules, it is most likely that web page will conform to the rules, or standards, adopted by most other search engines. The manner in which the test tool operates to implement step 210 is described below.

If the SEO test tool is invoked to check on the optimization of a published web page, the published page is selected at step 206 and step 212 is performed. If the web page selected by the user is not live, or activated, step 214 causes a display that the selected page is not found. If there are no published web pages, step 214 causes a suitable display that no web page is found. However, if the selected page is found, that is, if there is a published web page, step 216 is performed. That is, the plurality of tests of the SEO test tool are carried out to determine those data elements in the published web page that conform to the pre-defined rules, or standard, of the search engine. FIG. 2 identifies only some of the tests that are performed by the test tool. These tests, and the manner in which they are implemented, are described below.

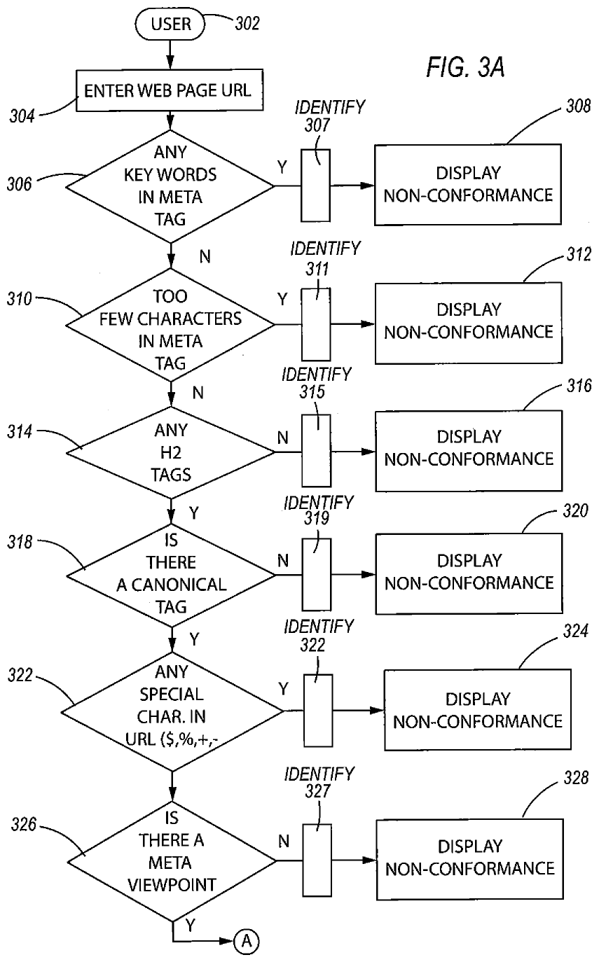

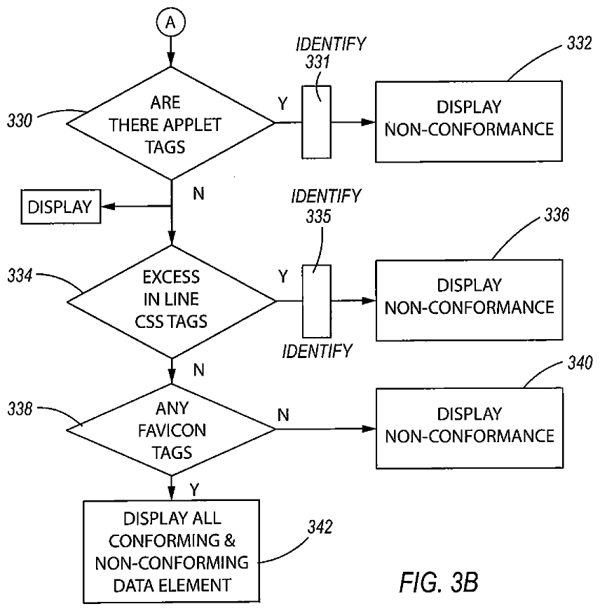

FIGS. 3A and 3B are flow charts that illustrate some of the tests carried out by the SEO test tool. Turning first to FIG. 3A, the tool begins at step 302 when the user invokes the tool, Such invocation may be voluntary, as by a deliberate selection of the test tool module by the user, or automatic when the web page is created. The web page for testing is selected by entering the URL of that web page, as indicated by step 304. When authoring a web page, its URL usually is one of the first data elements in the web page that is created.

It is recognized, web pages include several metadata tags. Many search engines, notably the Google search engine, do not permit key words in metadata tags. Inquiry 306 is made to determine if there are any key words in the metadata tags of the selected web page. If this inquiry is answered in the affirmative, the SEO test tool identifies, at step 307, a non-conforming data element; and at step 308 the test tool causes a display to indicate a non-conforming data element in the web page. Accordingly, a display, such as “meta keywords,” or a symbol associated with “meta keywords” is displayed.

As shown in FIG. 3A, the SEO test tool checks, or tests at query 310, whether the metadata description, that is, the description associated with the metadata tag, contains too few characters. For example, many search engines provide a lower limit on the number of characters included in the metadata description, for example, the number of characters included in the metadata description should be more than a predetermined number of characters, such as 100 characters. Query 310 is answered in the affirmative if less than this predetermined number of characters is included in a metadata description. Should this be the case, the SEO test tool identifies, at step 311, a non-conforming data element; and at step 312, the test tool causes a display to indicate the non-conforming data element, i.e. too few characters in the metadata description, in the web page.

The SEO test tool also tests, at inquiry 314, whether the web page being created contains any h2 tags. As is known, the data elements included in a web page include html tags and inquiry 314 asks whether any of the html tags included in the web page include h2 tags. Although not mandatory, the use of h2 tags is encouraged by virtually all search engines. If the web page does not contain any h2 tags, inquiry 314 is answered in the negative and the SEO test tool identifies, at step 315, a non-conforming data element and causes a display to indicate the non-conforming data element (step 316). If inquiry 314 is answered in the affirmative, a display of the values of the h2 tags is provided (not shown).

The SEO test tool tests, at inquiry 318, whether the web page being created contains a canonical tag. A canonical tag is a data element that identifies the URL of the page as the master copy of the page and is used by the search engine to avoid misinterpreting duplicate content that appears on several URLs being created. The canonical tag thus specifies the preferred version of the web page being created. If no canonical tag is present on the web page, inquiry 318 is answered in the negative and the SEO test tool identifies, at step 319, a non-conforming data element and causes a display to indicate the non-conforming data element (step 320). If inquiry 318 is answered in the affirmative, a display indicating the presence of the canonical tag is provided and, preferably, the value of that tag is displayed.

The SEO test tool tests, at inquiry 322, whether the author has created a URL that contains one or more special characters, such as the characters $, %, &, #, @, +, −. Search engines do not recognize special characters in URLs. If inquiry 322 is answered in the affirmative, that is, if there are special characters in the one or more URLs created for the web page, the SEO test tool identifies, at step 323, a non-conforming data element and causes a display to indicate the non-conforming data element (step 324). The display also may display a message that the special character(s) should be removed.

Web pages may be created for display on screens of different sizes, including mobile device screens. The web page should contain information directed to such screen sizes. This information is contained in a viewport metadata tag. The SEO test tool tests, at inquiry 326, whether the web page includes any viewport metadata tags. If this inquiry is answered in the negative, the SEO test tool identifies, at step 327, a non-conforming data element and causes a display to indicate the non-conforming data element (step 328). If this inquiry is answered in the affirmative, the display may display the characteristics of the viewport, such as display width, scale, etc. This display of the viewport characteristics is not mandatory.

The SEO test tool tests, at inquiry 330, whether the web page includes any embedded applet tags. Applets are used by a web browser to execute small applications, such as interactive features normally not provided by HTML. However, the recent version of the HTML environment (HTML 5) does not use applet tags. Accordingly, if inquiry 330 is answered in the affirmative, that is, if applet tags are present, the SEO test tool identifies, at step 331, a non-conforming data element and causes a display to indicate the non-conforming data element (step 332). On the other hand, if inquiry 330 is answered in the negative, the display may provide an affirmative message indicating no object, embedded applet tags are present.

Elements of a web page that is displayed often exhibit styles and color (as examples) preferred by the author. Such styles are noted as inline CSS to one data element (i.e. an HTML element) at a time. However; the use of several inline CSS elements may reduce the web crawling speed of the search engine, which negatively affects the ranking of that web page. Inquiry 334 tests whether the web page includes an excess number of inline CSS tags. If this inquiry is answered in the affirmative, the SEO test tool identifies, at step 335, a non-conforming data element and causes a display to indicate the non-conforming data element (step 336). In addition, the display may display the number of inline CSS tags that have been found and the locations of those tags.

The pre-defined rules of search engines recommend the presence of a favicon tag in at least one data element. As is known, a favicon is a tag that causes the display in a browser of a logo or stylistic image in the address bar of the web page. Although not mandatory, the presence of a favicon tag in the web page is recommended for optimization of that web page. Inquiry 338 tests whether the web page includes a favicon tag. If none of the data elements of the web page includes a favicon tag, this inquiry is answered in the negative and the SEO test tool causes a display to indicate the web page is non-conforming (step 340).

After running the tests described above, the SEO test tool causes the display to display all of the non-conforming data elements as well as all of the conforming data elements, as represented by step 342.

It will be appreciated, the foregoing description is not intended to limit the number and types of tests performed by the SEO test tool solely to those tests described above. Other tests of the web page, prior to its publication, are contemplated and expected.

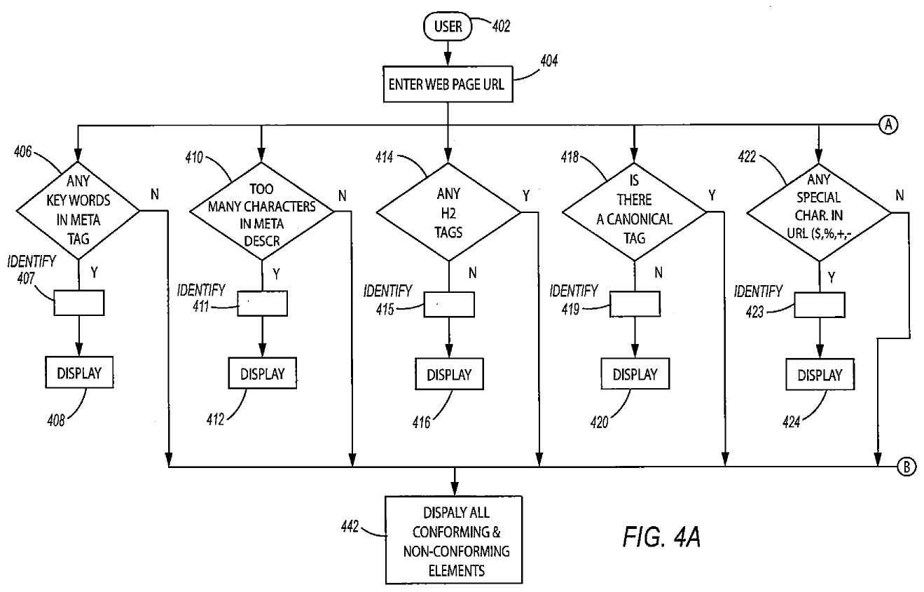

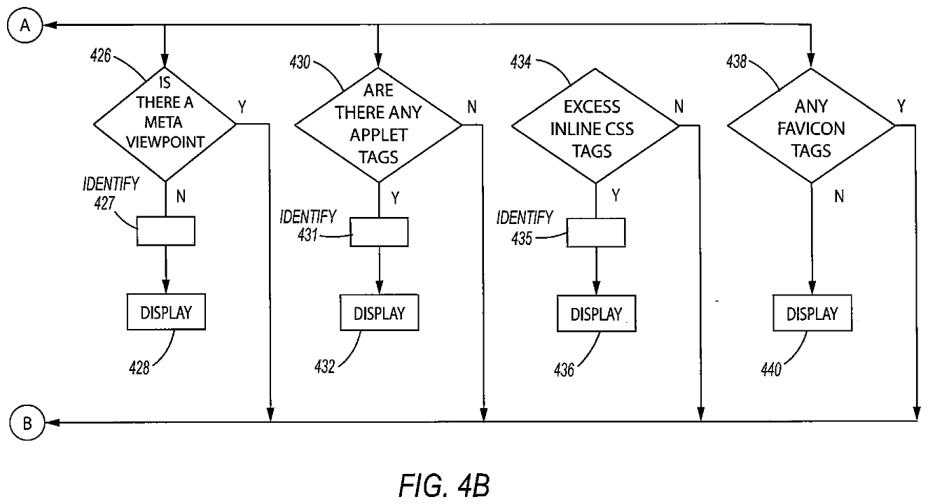

Furthermore, the tests performed by the SEO test tool and illustrated in the flow chart of FIGS. 3A and 3B need not be performed serially or in the order shown in the flow chart. The tests, if performed serially, may be performed in a different order. Moreover, the tests need not be performed serially, that is, there is no need to delay one test until a test shown in the flow chart as a preceding test, is completed. FIGS. 4A and 4B illustrate a flow chart showing the tests performed by the SEO test tool, in which the tests noted in FIGS. 3A and 3B are performed in parallel. It will be seen, the reference numerals 3XX to identify the elements shown in FIGS. 3A and 3B are shown as reference numerals 4XX to identify the same elements shown in FIGS. 4A and 4B. In the interest of avoiding unnecessary duplicative, redundant description, further description of the flow chart of FIGS. 4A and 4B is not provided. After running the tests shown in FIGS. 4A, 4B, the SEO test tool causes the display to display all of the non-conforming data elements as well as all of the conforming data elements, as represented by step 438.

As noted above in conjunction with FIG. 2, the SEO test tool may operate at step 212 on the web page that has been published. The tests performed at step 216 of FIG. 2 are substantially the same tests shown and described above with respect to the flow charts of FIGS. 3A, 3B, 4A and 4B. Accordingly, to avoid duplicative and redundant description, the tests performed on the published web page are not further described.

The process represented by the flow charts of FIGS. 3A 3B, 4A and 4B are implemented by the HTML code set out in the Appendix hereto. One of ordinary skill in the art will understand and be enabled to carry out the process described in the code of the Appendix.

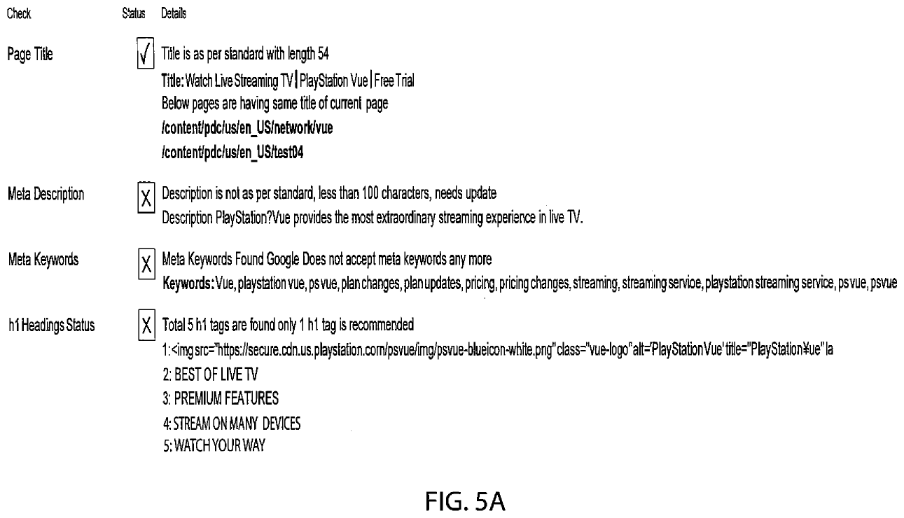

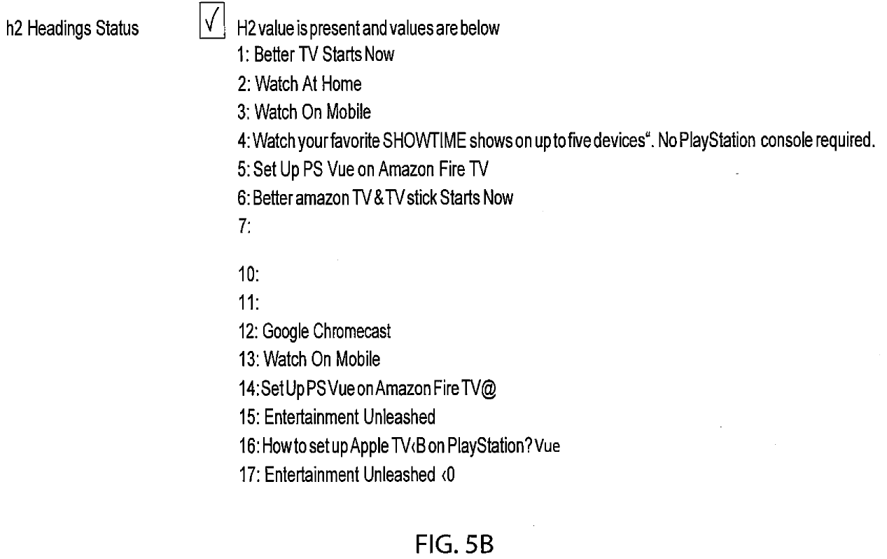

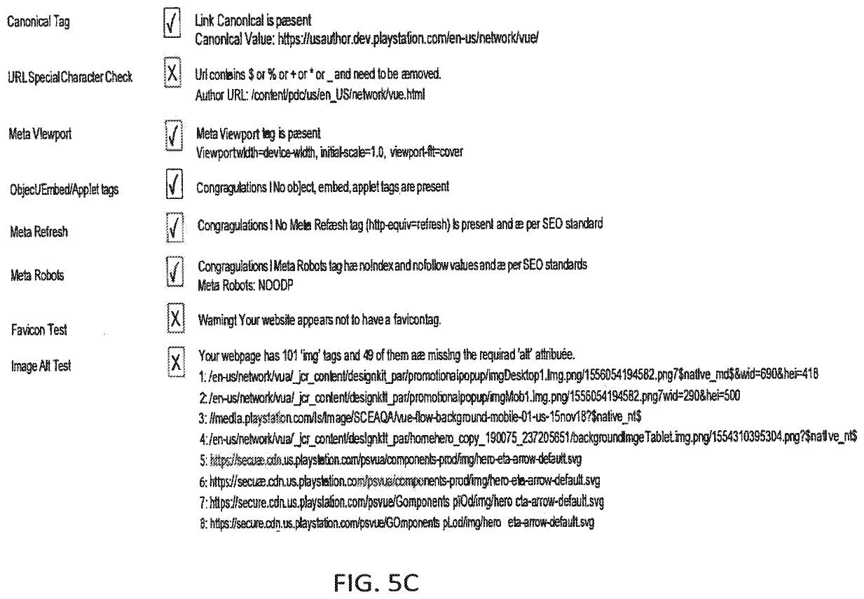

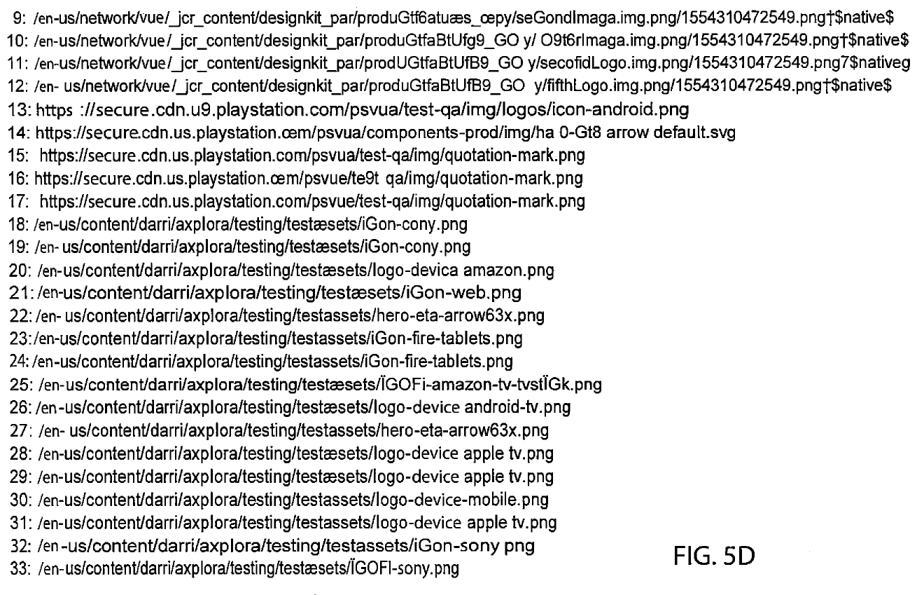

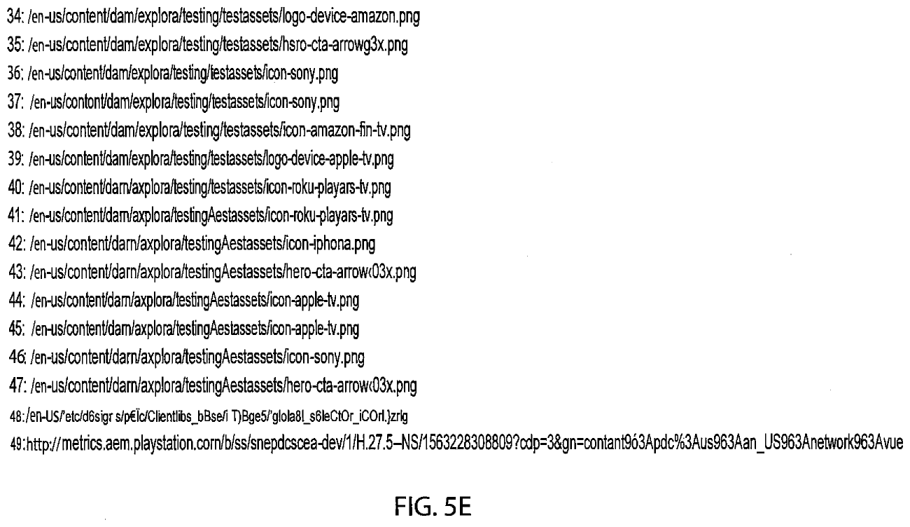

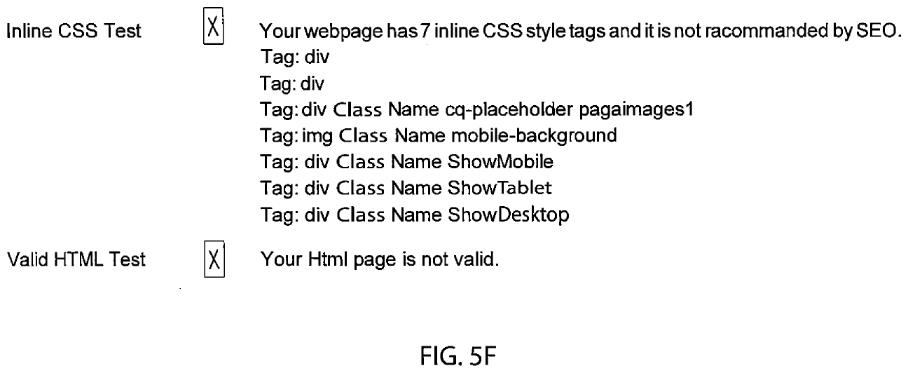

FIGS. 5A-5F illustrate the display of the test results obtained as a result of the tests performed on the data elements by the SEO test tool on the web page prior to publication. The tests that are performed are identified under the column heading “check.” The results of each test are indicated under the column heading “status” as conforming (indicated by the check mark) or as non-conforming (indicated by the mark “X”). And the details of the test results are indicated under the column “details.”

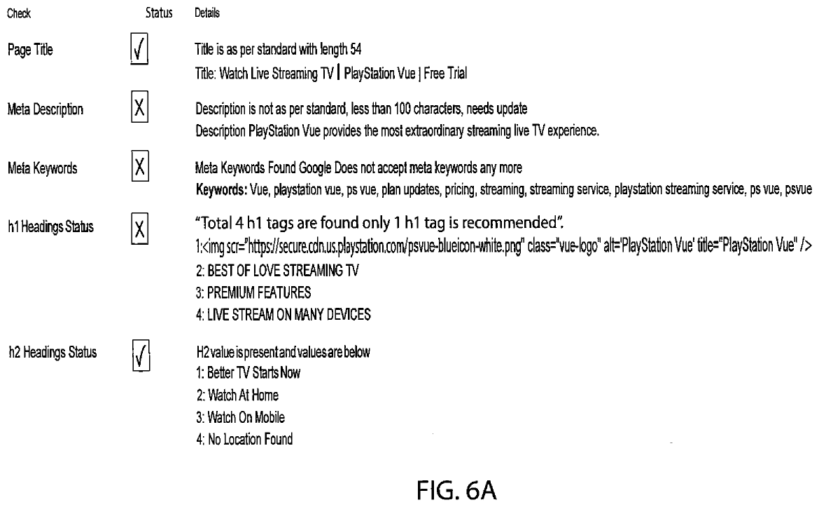

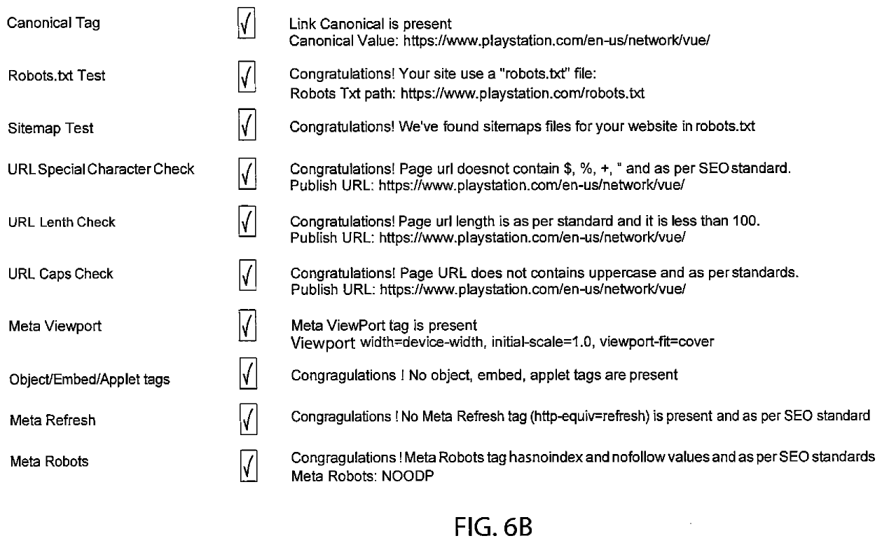

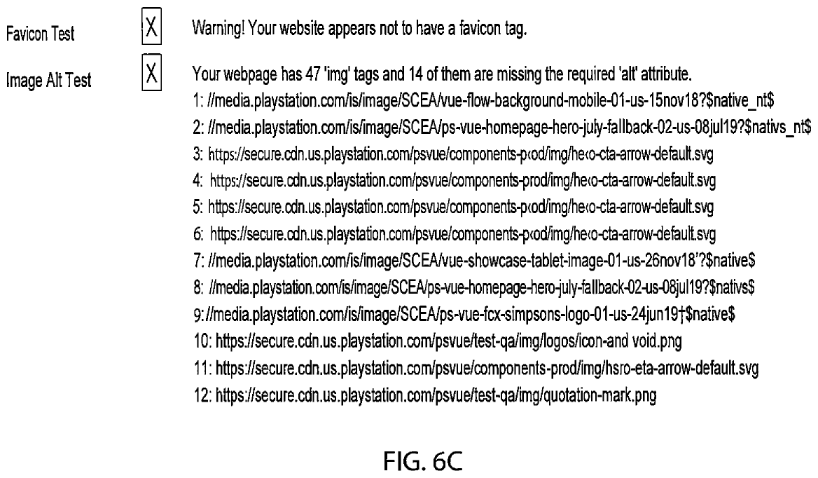

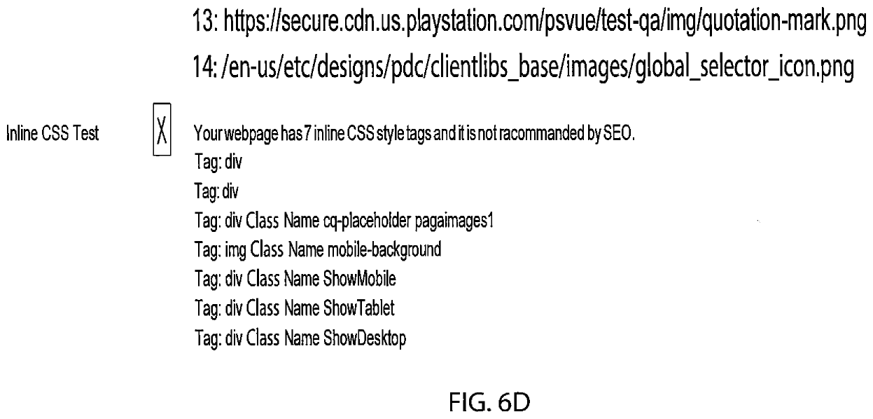

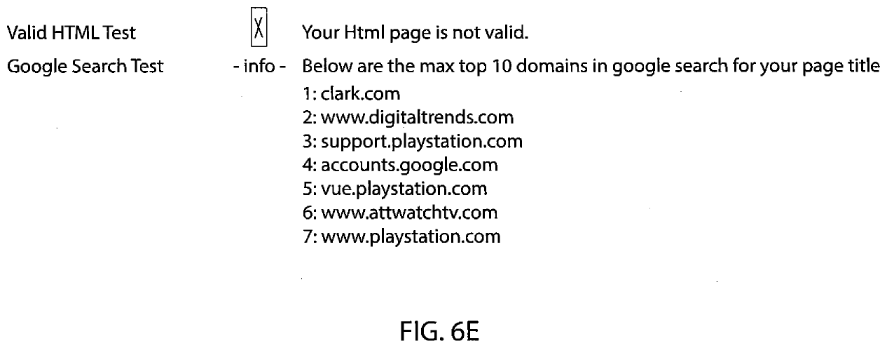

FIGS. 6A-6E illustrate the display of the test results obtained as a result of the tests performed on the data elements by the SEO test tool on the published web page, that is, the tests performed on the “live” web page. As is the case for FIGS. 5A-5F, the tests that are performed on the data elements, and the results of those tests are shown under the column headings “check;” “status” and “details.”

While the present invention has been shown and described with reference to certain preferred embodiments, it will be appreciated that various changes in form and details may be made, without departing from the spirit and scope of the invention. Some of those alternatives have been described. Others will be apparent. It is intended the appended claims be interpreted to cover the embodiments described herein as well as such other changes, modifications and variations that fall within the scope of the appended claims.

What is claimed is:

1. A search engine optimization (SEO) test tool for a web page authoring system operable to create a web page for publication, the web page authoring system and the SEO test tool being implemented as software executed on a computer, the web page authoring system being comprised of data elements having predetermined functions that conform to pre-defined rules established by the search engine, and the SEO test tool being implemented prior to publication of the web page, the SEO test tool comprising:
a plurality of tests to determine if at least predetermined ones of the data elements conform to the pre-defined rules and to identify conforming data elements that conform to the pre-defined rules and non-conforming data elements that do not conform to the pre-defined rules; and
an output to cause a display of at least some of the non-conforming data elements.

2. The search engine optimization test tool of claim 1, wherein the output causes a display of at least some of the conforming data elements.

3. The search engine optimization test tool of claim 1, wherein the data elements include a meta description and the SEO test tool identifies the meta description in the web page that does not conform to the pre-defined rules.

4. The search engine optimization test tool of claim 3, wherein the data elements include metadata tags, and the SEO test tool identifies, as a non-conforming data element, a metadata tag that includes a keyword.

5. The search engine optimization test tool of claim 1, wherein the data elements include html tags, and the SEO test tool identifies, as a non-conforming web page, a web page in which the html tags do not include any h2 tags.

6. The search engine optimization test tool of claim 1, wherein at least one of the data elements includes a URL address and the SEO test tool identifies, as a non-conforming data element, a data element that includes a URL address having a non-conforming character.

7. The search engine optimization test tool of claim 1, wherein the SEO test tool identifies the web page as non-conforming if a favicon tag is not included in any data element.

8. A search engine optimization (SEO) test tool for a web page authoring system operated on a computer system by a user to create a web page for publication, the SEO test tool being incorporated as a software module selectable for use by the user, the SEO test tool comprising:
a plurality of first tests, invoked by the user prior to publication of the web page, to determine if at least predetermined data elements of the web page authoring system conform to pre-defined rules established by the search engine and to identify those data elements that conform to the pre-defined rules and those data elements that do not conform to the pre-defined rules;
an output to cause a display of data elements that conform to the pre-defined rules and a display of data elements that do not conform to the pre-defined rules;
a plurality of second tests, invoked by the user after publication of the web page, to determine if certain data elements of a published web page conform to pre-defined rules established by the search engine and to identify those data elements of the published web page that conform to the pre-defined rules and those data elements that do not conform to the pre-defined rules; and
the output causing the display of data elements of the published web page that conform to the pre-defined rules and a display of data elements of the published web page that do not conform to the pre-defined rules.

9. The search engine optimization test tool of claim 8, wherein the data elements of both the published and unpublished web page include a meta description and both the first and second tests invoked by the user determine whether the meta description in the tested web page conforms to the pre-defined rules.

10. The search engine optimization test tool of claim 9, wherein the data elements of both the published and unpublished web page include metadata tags, and both the first and second tests invoked by the user determine whether the tested web page conforms to the pre-defined rules based on whether a metadata tag includes a keyword.

11. The search engine optimization test tool of claim 8, wherein the data elements of both the published and unpublished web page include html tags, and wherein both the first and second tests invoked by the user determine whether the tested web page conforms to the pre-defined rules based on whether the html tags of the web page do not include any h2 tags.

12. The search engine optimization test tool of claim 8, wherein at least one of the data elements of both the published and unpublished web page includes a URL address, and wherein both the first and second tests invoked by the user determine whether the tested web page conforms to the pre-defined rules based on whether the URL address of the tested web page has a non-conforming character.

13. The search engine optimization test tool of claim 8, wherein both the first and second tests invoked by the user determine whether the tested web page conforms to the pre-defined rules based on whether a favicon tag is included in at least one of the data elements in the tested web page.

14. A method for search engine optimization for a web page authoring system operated by a user to create a web page for publication, comprising:
prior to publication of the web page, determining if at least predetermined data elements of the web page authoring system conform to pre-defined rules established by the search engine, and determining those data elements that do not conform to the pre-defined rules; and
displaying at least some of the data elements that conform to the pre-defined rules and displaying at least some of those data elements that do not conform to the pre-defined rules.

15. The method of claim 14, wherein the data elements include a meta description and the SEO test tool identifies the meta description in the web page that does not conform to the pre-defined rules.

16. The method of claim 15, wherein the data elements include metadata tags, and a data element is displayed as nonconforming to the pre-defined rules if a metadata tag includes a keyword.

17. The method of claim 14, wherein the data elements include html tags, and a web page is displayed as a non-conforming web page if the html tags of that web page do not include any h2 tags.

18. The method of claim 14, wherein at least one of the data elements includes a URL address, and a data element is displayed as a non-conforming data element if that data element includes a URL address having a non-conforming character.

19. The method of claim 14, wherein the web page is displayed as non-conforming if a favicon tag is not included in any data element.
